(19) United States
(12) Patent Application Publication
(10) Pub. No.: US 2004/0117442 A1
(43) Pub. Date: Jun. 17, 2004

(54) Handheld portable wireless digital content player

(76) Inventor: Kurt R. Thielen, Maple Grove, MN (US)

Correspondence Address: Stuart R. Hemphill, DORSEY & WHITNEY LLP, Intellectual Property Department, 50 South Sixth Street, Suite 1500, Minneapolis, MN, 55402-1498, US

(21) Appl. No.: 10/730,692

(22) Filed: Dec. 8, 2003

Related U.S. Application Data
(60) Provisional application No. 60/432,034, filed on Dec. 10, 2002.

(51) Int. Cl. G06F 17/00; G06F 15/16

(52) U.S. Cl. 709/203; 709/217; 709/219; 700/94

(57) ABSTRACT

A portable handheld digital content player has an integrated wireless interface, an integrated FM transmitter and an integrated auto on and auto off feature for ease of use in vehicles. The player and associated software on a base content server provide automated broadband wireless content downloads to the player while in a vehicle and transfer of audio to the vehicle stereo via FM band transmission without the use of an accessory. The player integrates an FM scan function to search for a suitable frequency for transmitting within the FM band. The player integrates some PDA-like functionality including personal contact information, appointment calendar, user schedule, email in addition to others.

### CROSS-REFERENCE TO RELATED APPLICATIONS

The present application claims the priority of U.S. provisional patent application No. 60/432,034 filed Dec. 10, 2002, the entire contents of which are incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Background—Field of Invention

This patent relates generally to digital content hardware players, in particular to a handheld digital content player, and more specifically a wireless handheld digital content player which functions as a portable digital audio player, commonly referred to as an MP3 player, or a digital video player or both.

2. Background—Discussion of Prior Art—Portable Players

Digital audio players, commonly referred to as MP3 players, generally fit into one of four categories. They are handheld portable players, in-dash automotive players, fixed-mount automotive players and stereo component players. The handheld portable players are designed for use on the go, with built in batteries, digital storage and a stereo headphone jack to be used with headphones. The in-dash automotive players run on vehicle battery power and use either CD ROMs or digital storage for memory and fit into the dash radio cavity of a vehicle. Fixed mount vehicle players are fixed in the vehicle somewhere other than the dash radio cavity and generally require some type of remote control for operation at the front seat. The last type is a stereo component player that is designed for use with home audio systems, operating as one of many components of the home audio system.

The present invention is a multi-purpose player that can be effectively used in all four-product categories without significant drawbacks inherent with other players generally designed for use in only one category. Additionally, this multi-purpose player provides features and functions that don't exist in any other players of any type.

Below is a detailed description of the prior art for existing players in these traditional player categories and the advantages and disadvantages of these players in their respective categories.

### Background—Discussion of Prior Art—Portable Players—With Respect To Song Variety

The prior art portable digital content handheld players have significant drawbacks with respect to getting new content and keeping a good variety of content on the player. It's commonly known that the users of music players like to listen to a variety of music; in fact, they like to have access to as much variety as possible each time they use their player. However, that variety requires either a lot of content storage or it requires the user to update the content in the player on a frequent basis. Updating the content on a daily basis is laborious and time consuming, something users dislike, forget to do or become tired of doing. The result is the player frequently has stale content, that is to say the content has been listened to since it was downloaded to the player. The result is a player that doesn't get use.

The handheld portable players come in a variety of sizes and shapes and store content using a variety of methods. The storage methods include either non-volatile read and write memory, removable read and write non-volatile memory, removable digital disks, or internal hard disk drive memory. Examples of each of these players are the SonicBlue Rio 600, the Samsung Yepp, the DataPlay and the Apple ipod, respectively. These content storage methods have significant limitations and drawbacks as discussed below.

(a) Non-removable non-volatile read and write memory, used by the Samsung Yepp player, prevents the user from adding more storage to the player. Thus using this method, the manufacturer either includes a lot of memory at time of manufacture time, which adds significant initial cost or it minimizes the amount of memory at manufacture time, which minimizes the amount of content that can be stored on the player.

(b) Removable non-volatile read and write memory, used by the SonicBlue Rio 600 allows the amount of memory to be increased after purchase. This allows the manufacturer to minimize the amount of memory installed at manufacture time, which reduces initial product cost while allowing the user to add memory later. However, the cost of removable non-volatile memory per megabyte is higher than non-removable read and write memory and significantly higher than hard disk drive memory.

(c) Removable digital disks media, used by DataPlay, eliminate the use of content storage internally, thus saving money. However the digital disk require a digital disk burner to store the content onto the media. This is an additional cost, added complexity and very time consuming.

### Background—Discussion of Prior Art—Portable Players—With Respect To Content Update

The prior art methods of getting content onto the digital content player consist of hard wired physical interfaces. The interfaces most commonly used included the USB interface (SonicBlue Rio600), the Serial Port interface (Pontis SP600) and the FireWire interface (Apple ipod) among others. The wired approach has both advantages and disadvantages with respect to a wireless solution proposed by the present invention. The advantages of wired interfaces include:

(a) Speed. Wired interfaces are generally faster than wireless. This is significant if the user is downloading a very large amount of content and if the user is manually performing the download and waiting for it to complete.

(b) Security. The wired connection is less prone to a security breach, since it requires physical access to the content server.

(c) Cost. The cost of wired technology is less than wireless connection technologies.

However, the wireless interface used by the present invention has significant advantages over the wired solution. They are:

(a) Physical Access. A wired interface requires the player and the content server to be physically attached via a wire, requiring the user to bring the player to the content server for content updates. A wireless interface allows the player to be updated with new content without physical access to the host server. This enables the player to receive new content even if the player is left in the car, in the garage or in a room away from the content server.

(b) Time. Because the wired interface requires that the player be physically attached to the content server, the content download is a manual process that requires user action. To perform a content download with a wired solution, the user must plug the player into the connecting cable, then the cable must be connected to the content server, the user must initiate the download via the computer program interface, then they must wait for the content download to complete and then disconnect the player from the content server. This operation can take a significant amount of time and must be performed frequently if new content is desired on the player frequently. A wireless interface on the other hand, allows the download to take place without physical access and without user intervention. The automated method of content update using a wireless interface enables time sensitive content, like sports, weather and news, to be downloaded to the player on a daily basis without the significant and recurring user effort required by the wired solution.

### Background—Discussion of Prior Art—Portable Players—With Respect To PDA functionality

The low cost portable players have an architecture that is very specialized for decoding and playing audio content. They generally use a special purpose audio processing chip that is limited in terms of processing power and the support of general-purpose operating systems. The present invention utilizes a general-purpose processor specifically to support a full-featured operating system to enable personal digital assistant (PDA) functionality as well as other desirable features described below.

### Background—Discussion of Prior Art—Portable Players—With Respect To Vehicle Use

Many digital content owners use their portable players in their vehicle. Portable players are used, versus installing a fixed solution in the vehicle, for a variety of reasons including cost, convenience and the expense or dislike for replacing the existing vehicle stereo. Because of the complexity, expense and intrusiveness of installing an aftermarket in-dash or fixed player into a vehicle, many users are unwilling to permanently install them into their automobiles. Additionally, many users have more than one automobile, thus a fixed player does not allow for multiple vehicle use. For these reasons, users often rely on a portable player that provides more utility and portability between vehicles.

### Background—Discussion of Prior Art—Portable Players with Accessories

Using a portable player in a vehicle while using the vehicle stereo for sound, can be achieved by using a portable player in conjunction with an external accessory like a cassette adapter, an FM modulator or a FM transmitter to transport the music from the player to the vehicle's built-in stereo system. These accessories are connected to the portable player lineout interface and transmitted to the automobile's stereo system. There are however, many problems with the use of a portable player with accessories in the vehicle environment, which make this solution undesirable. Since the portable players are not designed to operate in a vehicle environment, they don't come with the functional support required to have a seamless fixed installation user experience in the vehicle. For example, the player, and all accessory components ideally would go on when the vehicle goes on and go off when the vehicle goes off without manual user intervention. Ideally, the player would have a mounting system that minimizes the attachment and detachment to the dash. Finally, ideally the installation would require non-permanent damage and be very quick to install and uninstall.

### Background—Discussion of Prior Art—Portable Players—Operation in Vehicles

All prior art portable players including the SonicBlue Rio, Samsung Yep, Apple iPod, require external accessories for vehicle use. Prior art players either run on batteries or an external power cord attached to the vehicle's 12 v power accessory port. The external accessories also require external power from the 12 v power source. This results in the user having to plug in one or more accessory power cords prior to operation of the player each time the user enters the vehicle. If the accessory is a cassette adapter, it also requires the insertion of the cassette adapter into the cassette deck. Then the player and the accessory need to be turned on, then the user must hit the play button to begin play. Obviously, this is a lot of effort each time the user enters the car with the portable player. When the user exits the vehicle with the player, the player must be detached from the accessory and the vehicle 12-volt power adapter and the accessory and the player need to be turned off.

If the user prefers to leave the player in the car after their commute, to prevent battery drain the player and the accessory must be manually turned off each time the user exits the car and turned on each time the user enters the car. Each time the user enters the vehicle, the player and the accessory must be turned back on. These repetitive manual steps are very inconvenient to the user and often encourage the user to seek an alternative solution.

### Background—Discussion of Prior Art—Portable Players—Content Download Mechanisms

Conventional prior art portable players require manual intervention to load new content onto the player and require that the player be disconnected from the vehicle and the accessory unit and connected to the content server for manual download. Once the content is downloaded, the reverse actions must be done to re-enable the player in the vehicle. Obviously, this is less than ideal for the user.

The present invention addresses one or more shortcomings of the prior art by:

(a) automatically turning the player on and off when the vehicle is started, by sensing the state of the vehicle,

(b) not requiring the use of any external accessories,

(c) not requiring the player to be removed from the car for content downloads,

(d) having a mounting system which supports directional adjustments for the user,

(e) having a mounting system that is a one-step mount and power source interface eliminating a two-step install process.

The combination of these features makes this player unique and novel relative to all known portable players for use in a vehicle.

### Background Discussion of Prior Art for Automotive Digital Content Players

The prior art for automotive digital content players include in-dash CD ROM players, in-dash hard disk drive players, fixed-mount multiple CD ROM changer players, fixed-mount hard disk drive players and portable players used in conjunction with an accessory. The limitations of each of these prior art solutions are described in the following paragraphs.

### Background Discussion of Prior Art for in Dash CD ROM Players

In dash CD ROM digital content players (like the Sony CDX-MP30) require the digital content to be stored on CD ROM media. The size and delicate nature of the CD ROMs make the use and storage of them in vehicles difficult and something many users avoid. Additionally, the task of burning songs onto the CD ROMs is a time consuming laborious process, which requires the use of expensive and difficult to install CDROM burners. Finally, many consumers don't want to replace the current stereo in their car with an after-market stereo for one of several reasons.

### Background Discussion of Prior Art for Hard Disk Drive in Dash Players

In-dash hard disk drive digital content players, like the Empeg Car MP3 Player, require installation of the player into the stereo cavity in the vehicle dash. Prior art for this player type is for the user to remove a portion of or the entire player from the vehicle to update the digital content, requiring it to be brought in proximity to the content server and plugged in for the content download. Once the download of content completes, the player is unplugged and replaced in the vehicle.

This player has many drawbacks including the need to remove the factory stereo system, installation of the new player, difficult content updates and common failure. The present invention does not require a fixed installation, does not require removing the factory stereo, and does not require removal to update the content.

### Background Discussion of Prior Art for Fixed Mount CD ROM Players

Fixed mount CD ROM digital content players, like the Kenwood Changer KDC-C717 player, are generally installed and fixed in the trunk, under a seat or somewhere else in the car. These players work very similarly to CD changers. There are several drawbacks with this type of a system. New content must be burned onto compact disks, a very laborious and time consuming task. Random play of content requires the physical action of removing a CD ROM from the CD reader, placing it in storage slot, retrieving another CD from a storage bay and placing it into the CD ROM reader. This process incurs a long delay between the play of one song on one disk to the next song of the next disk, a significant annoyance to the user. Disk reading errors can occur during rough road conditions causing the song to skip while being played. This type of player requires time consuming and expensive installation. The present invention does not require significant installation, doesn't require the use of CD ROMS, doesn't require fixed space in the trunk or under a seat and generally doesn't have a song skip problem.

### Background Discussion of Prior Art for Fixed Mount Hard Disk Drive Players

Fixed mount hard disk drive digital content players, like the Kenwood KHD-CX910 Music Keg, are similar to Fixed Mount CD ROM players, commonly referred to as CD Changers, except the digital content is stored on a hard disk drive instead of a number of CD ROMs. The fixed mount hard disk drive player must be installed somewhere in the automobile and be connected to the player via wire. These players are often quite expensive because of the required durability, the costly installation, the amount of storage on them and the remote control mechanism required to operate them. Getting new digital content onto the system is difficult, since a portion of the player must be removed from the unit, often installed in the trunk, every time new content is added. Once the content is added, the storage unit must again be stored in the vehicle. The process of storing new content on the player is a manual labor-intensive process. The present invention does not require significant installation and doesn't require the use of a fixed space in the trunk or under a seat for player storage. Additionally, the player that is the object of this invention does not require manual intervention for recurring content downloads.

### Background Discussion of Prior Art for Component System Digital Content Players

A component system digital content player is a player that is designed to be one of many components in a multi-component home stereo system. The prior art component system digital content players use one of several techniques to both store and transfer the digital content from the content server to the player. These players are discussed below in more detail.

### Background Discussion of Prior Art for Component System with Removable Non-volatile Read and Write Memory

Prior art digital content component players with removable non-volatile read and write memory require the user to remove the non-volatile memory from the player to update the content on the player. This is not desirable, since this task must be performed whenever new content is placed on the player. Additionally, the amount of non-volatile memory used must be relatively large so that a reasonable amount of content can be stored between content updates. The amount of memory required to achieve this is significant, resulting in a significant expense for the consumer. The present invention doesn't require user intervention to add content, and, since the content can be updated frequently or continuously, it doesn't require a tremendous amount of non-volatile memory.

### Background Discussion of Prior Art for Component Systems Hardwired to the Content Server

Prior art for Component Systems using a hard-wired connection between the player and the content server, like the Dell DAR, have significant drawbacks. They require physical connectivity from the content server to the location of the stereo system. This is generally achieved using either Ethernet or twisted pair telephone wires. The obvious drawback of this technique is that a physical wire must either exist or be added between the content server and the location of the component player. Another drawback of this architecture is that the content server must be active for the player to be used. The present invention doesn't require the player to be hard-wired to the content server, since this connection is done wirelessly. Secondly, the content server doesn't need to be powered on for use, since the player has internal and removable storage for content. Finally, the player doesn't require a lot of content storage, since it can be updated frequently or continuously without manual user interaction.

### Background Discussion of Prior Art for Wireless Digital Content Component Systems

The prior art for component systems using a wireless transport for streaming content, like the Motorola Simplefi, has both pros and cons. It does avoid the need of wires between the player and the content server, but it still requires the content server to be on for play. A second drawback to this solution is that radio frequency interference can disrupt the flow of the streaming digital, thereby causing audio disruptions in the played music content. The present invention doesn't require the content server to be powered on for use, since the player has internal and removable storage for content. Secondly, the present invention plays content from cached music instead of playing streaming music, which eliminates the possibility of music content being disrupted.

### Background Summary of Prior Art

As described above, the prior art for hardware digital content players fit into one of three categories including portable, automotive and component systems. Each of these systems have limitations in their respective categories as well as limitations when used in a category other than it was intended for. The portable players are cumbersome to use in the automobile. The current automobile players require time consuming and costly installation and require either removal of the existing in-dash player or compatibility with it. The component players are not used in portable or automotive mode and have significant limitations in their own category. The bottom line is that no existing player functions effectively in all of these categories.

### BRIEF SUMMARY OF THE PRESENT INVENTION

As described above, the present invention has features and functionality that make it an effective multi-purpose player for use as a portable, a vehicle, and a home digital content player. The player is not only multi-use, but it also has many features not found in any of the prior art players.

The present invention effectively functions as a portable, a vehicle, a desktop and a component digital content player all in one. This player eliminates many of the drawbacks associated with the prior art digital content players in each of the market segments they address.

The present invention is a handheld portable digital content player that uses broadband wireless networking technology to download content from the content server to the player, and for use as an electronic control interface to fully and remotely control the player wirelessly.

In one embodiment, the present invention has an integrated FM transmitter that transmits digital audio content from the player to any FM receiver.

In one embodiment, the present invention contains an FM band scanner able to scan and find the FM frequency with the lowest signal strength to transmit over, providing for the best possible quality FM transmission and reception.

In one embodiment, the present invention integrates a means to detect the vehicle running status, based on battery voltage, to determine when to enable and disable play of the player.

In one embodiment, the present invention has a docking station connector used as an alternate content download interface, a power charging interface, a digital content output interface, an analog content output interface and an electronic control interface.

In one embodiment, the present invention has a second docking connector used for a vehicle docking connector with analog content output, digital content output and a power input.

In one embodiment, the present invention contains rechargeable batteries and battery charging circuitry for operation without external power and for battery recharging, respectively.

In one embodiment, the present invention provides the ability to record audio content based on a predetermined record schedule to result in the time shifting of content from when it is played to when it is listened to.

### BRIEF DESCRIPTION OF THE SEVERAL VIEWS OF THE DRAWING

### Drawing Figures

The drawings following show the embodiments of the invention.

The figures are as follows:

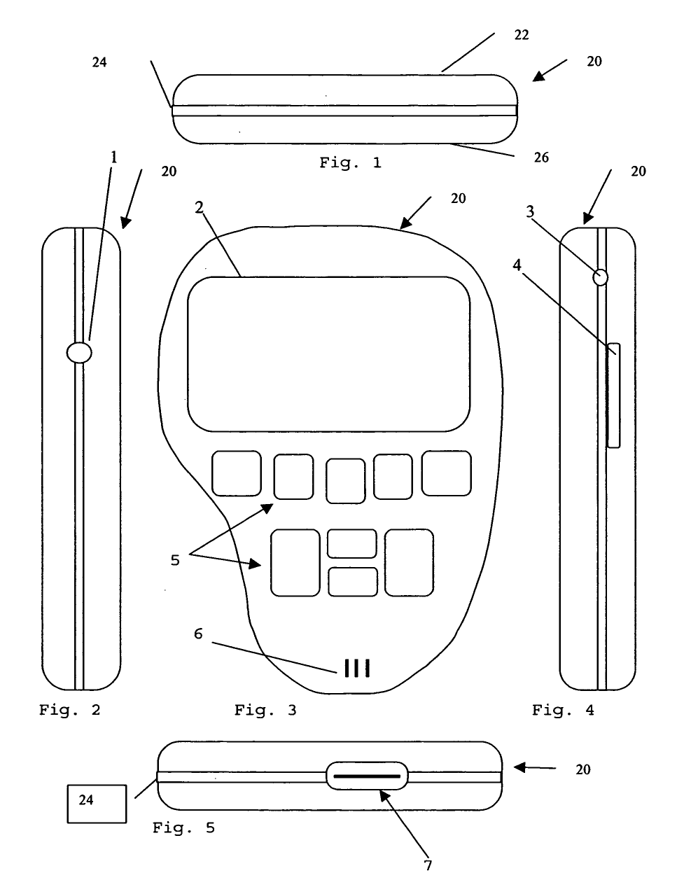

FIG. 1 is a top view of the player.

FIG. 2 is a left side view of the player.

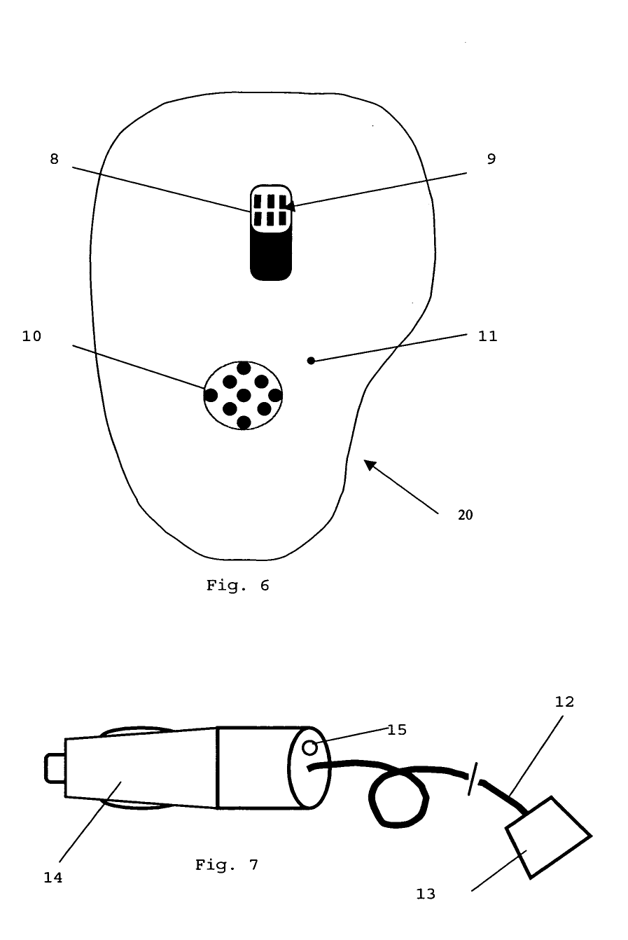

FIG. 3 is a front view of the player.

FIG. 4 is a right side view of the player.

FIG. 5 is a bottom view of the player.

FIG. 6 is a back view of the player.

FIG. 7 is a pictorial view of the power cord and audio output combo.

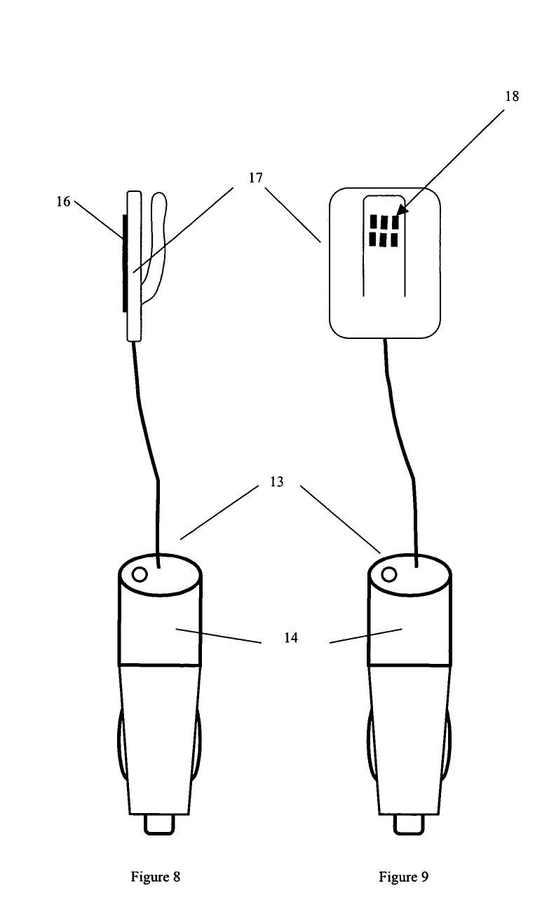

FIG. 8 is a pictorial side view of the dash mount and power cord.

FIG. 9 is a pictorial front view of the dash mount and power cord.

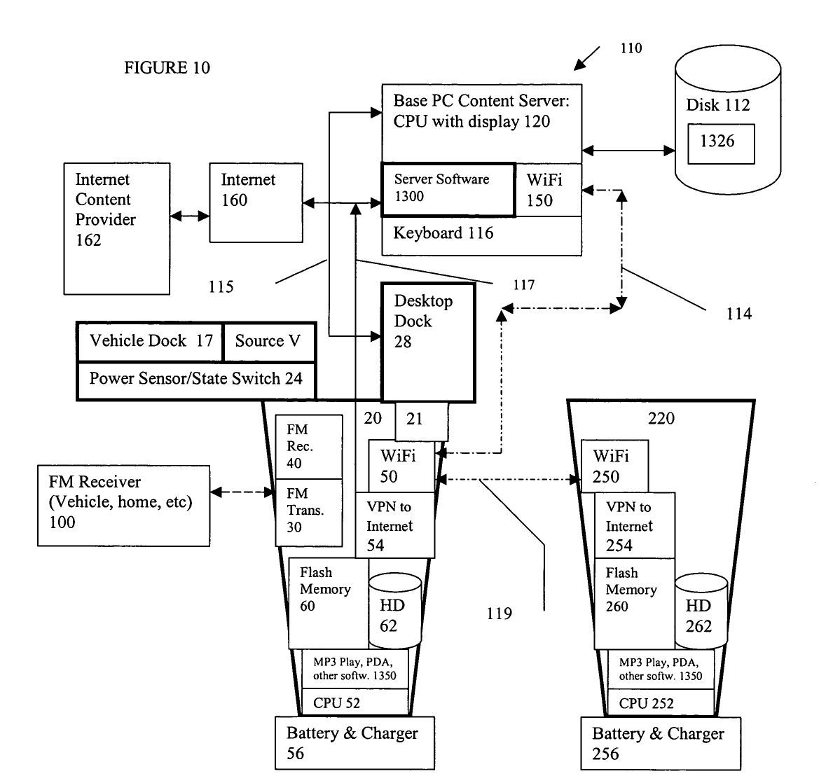

FIG. 10 is a schematic block diagram showing the player of FIGS. 1-6 with a base personal computer (PC) acting as content server and a second, peer player, as well as the environment in which the players and the base PC operate.

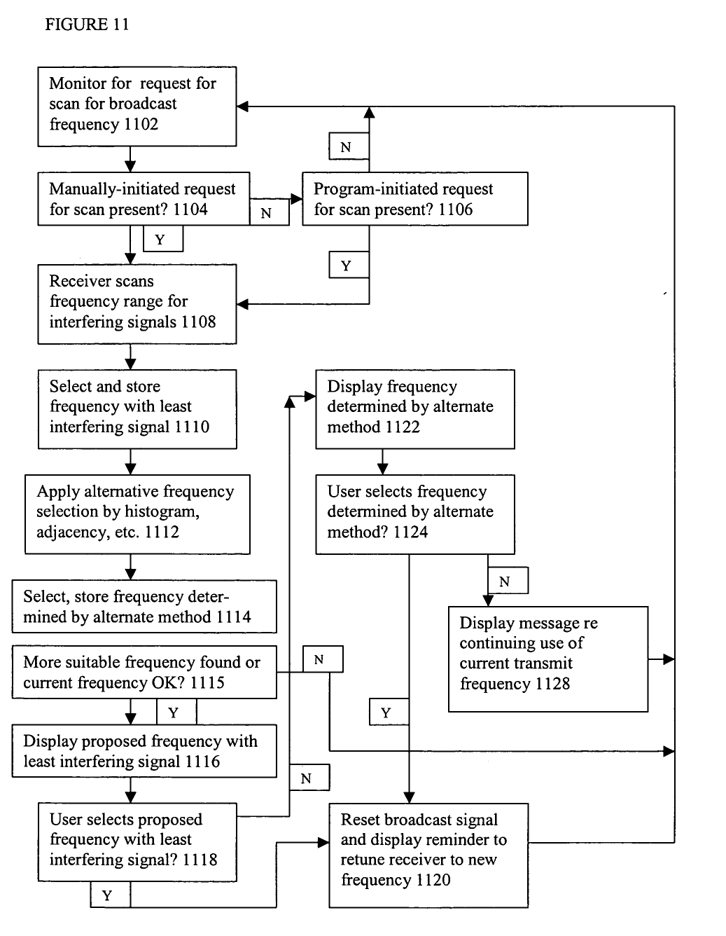

FIG. 11 is a flow chart showing the FM transmitter frequency search with both manual and automatic options.

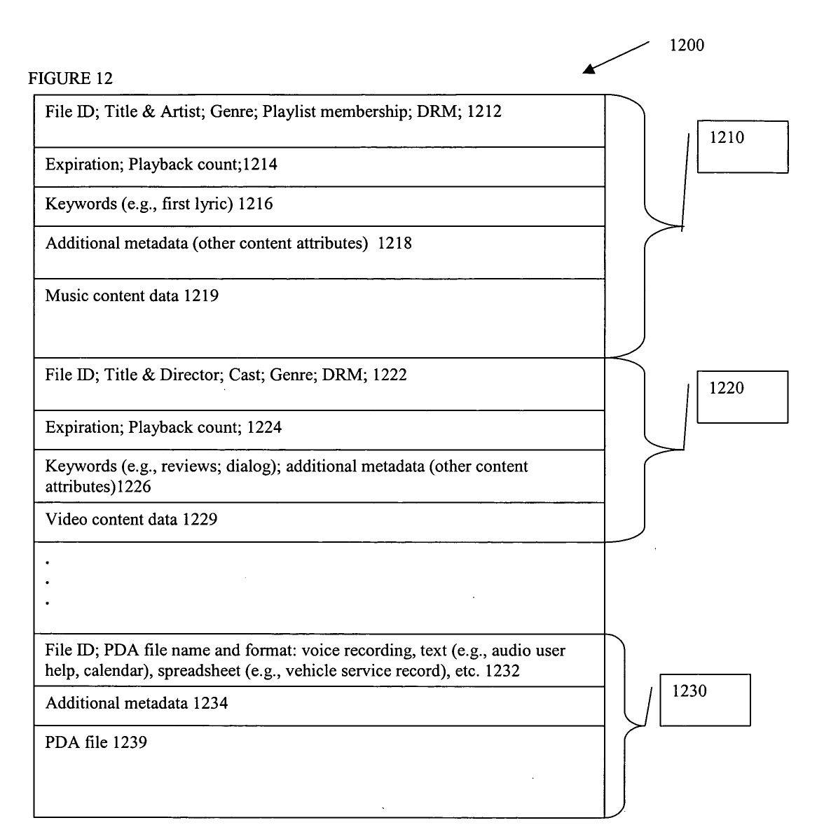

FIG. 12 is data layout diagram showing file formats for information stored on the player.

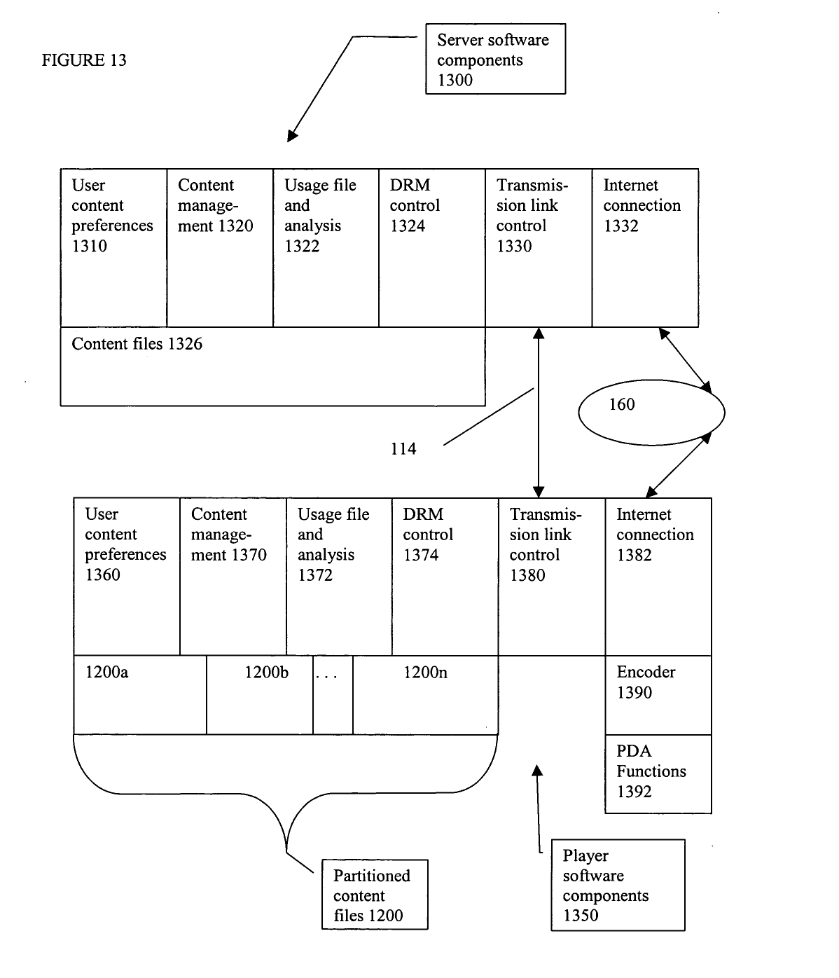

FIG. 13 is a schematic diagram showing certain software components on the content server and the player.

### DETAILED DESCRIPTION OF THE INVENTION

The present invention is a portable handheld digital content player 20 with a wireless link for content loading from a content server 110. Audio digital content players are commonly referred to as MP3 players. The present player may play back video in addition to audio content and also use a general-purpose microprocessor 52 to provide PDA functions.

In one embodiment, the invention is a wireless digital content recorder and player with a means to wirelessly store and record digital content and to play digital content using a printed circuit assembly to connect via a bus:

(a) a microprocessor,

(b) a random access memory,

(c) a digital to analog content decoder,

(d) a nonvolatile memory,

(e) a wireless interface,

(f) a display,

(g) an audio output interface.

The player also includes a power source and is enclosed in a housing or casing. The player is configured to receive digital content from a computer automatically and wirelessly without having to be physically attached or collocated with the computer and without human interaction.

In another embodiment, the player further includes: a keypad, a stereo headphone jack, and a battery. This player is portable and handheld whereby it can be easily used with one hand, put in a pocket or attached to a user's belt. It can also include a means to charge the battery.

In one embodiment, the player has a means to download content to the player at broadband speeds whereby the player is capable of downloading substantially large amounts of content in substantially short periods of time.

In another embodiment, the player's wireless interface is a local area network wireless interface for transmitting digital content from a computer with a wireless local area network to the player, utilizing said wireless local area network interface. In such an embodiment, the player's local area network wireless interface may utilize a standard off-the-shelf local area network wireless interface card, which can be easily removed and replaced with a next generation or cost reduced version without player hardware redesign.

In one embodiment, the player further includes a docking connector interface adapted to attach the player to a docking station or a multi-use power cord, whereby the docking connector interface can be used to interface to a desktop docking station or an electrical cord for powering the player, recharging the battery and for exchanging data and control information between the player and the content server. Specifically, the docking connector interface may include: a docking connector power interface, a docking connector analog audio interface, a docking connector digital audio interface, a docking connector universal serial bus interface, a docking connector data interface, and a docking connector control interface, wherein the player is easily mounted to and dismounted from the docking station, providing power to the player via said docking connector power interface, analog audio output via said docking connector analog audio interface, digital audio output via said docking connector digital audio interface, a serial bus interface via said docking connector universal serial bus interface, a data interface to an external computer via said docking connector data interface and a control interface to an external computer via said docking connector control interface. In an alternate embodiment, the docking connector interface connects to a player interface cord, whereby the cord provides an electrical interface between the player and other devices supporting all of the interfaces supported by the docking connector interface. In a further alternative embodiment, the docking connector interface connects to a player docking station whereby the docking station provides an electrical interface between the player and other devices supporting all of the interfaces supported by the docking connector interface.

In one embodiment, the player further includes a dash mount connector comprising:

(a) a dash mount connector power interface,

(b) a dash mount connector analog audio interface,

(c) a dash mount connector digital audio interface,

(d) a dash mount connector control interface, and

(e) a dash mount connector data interface.

With this dash mount connector the player is easily mounted to and dismounted from a vehicle dash, providing power via said dash mount connector power source interface, providing analog audio output via said dash mount connector analog audio interface, providing digital audio via said dash mount connector digital audio interface, providing a control interface which can be used to externally control the player via said dash mount connector control interface, and providing a method to exchange data with an external computer via said dash mount connector data interface, all via said dash mount connector. In this embodiment, the player's dash connector interface also may connect to a player interface cord whereby the cord provides an electrical interface between the player and another device supporting all of the interfaces supported by the dash connector interface.

In one embodiment, the player includes an FM transmitter as a means to transmit audio content from the player to an FM receiver without the use of external accessories. The player also includes an FM band signal strength scanner configured as a means to automatically and upon user request scan the FM band for the frequency having the weakest signal strength, thereby finding and identifying the FM frequency best suited for transmission and quality reception.

In another embodiment, the player operates a general purpose data processor to execute an object program with:

(a) a data and control interface utilizing either a wireless interface or a docking connector interface wherein content updates to the player are initiated from the player so that the user can get content updates without having access to or without being physically connected to the content server,

(b) a data and control interface utilizing either the wireless interface or the docking connector interface to exchange digital content with a remote computer, initiated manually or automatically and done as a single instance or on a recurring basis when initiated by a remote computer,

(c) a data and control interface utilizing either the wireless interface or the docking connector interface to exchange digital content with a remote computer, initiated automatically by the remote computer based on a predetermined schedule, thereby automating the download of digital content from the content server computer to the player,

(d) a data and control interface utilizing either the wireless interface or the docking connector interface to stream digital content from a remote computer based on predetermined content preferences configured on the remote computer to the player, whereby the player receives new content continuously based on the user's preferences, and

(e) a data and control interface utilizing either the wireless interface or the docking connector interface to download digital content from a remote computer based on predetermined content preferences configured on the remote computer to the player immediately upon the completion of playing content already on the player, replacing the previously played content with new content from the remote computer, whereby the player receives new content based on predetermined preferences as the content on the player is played, thereby replacing played content with new fresh content.

With such a player, a reduced amount of content is downloaded from the content server to said player by recognizing the content which has not yet been played since downloading to the player and not replacing it during a content update as long as the content is consistent with the type of content scheduled to be downloaded to the player. Thus, a manual or automatic content update can be achieved in less time by preserving content on the player which has not yet been listened to. Time sensitive content, being content that has an expiration date associated with it, will be replaced during content updates if the expiration date has passed, whereby time sensitive content is replaced on the player when it expires whether it has been played or not. The player may further implement a means of replacing stored digital content on the player immediately following the completion of played content such that the player requests and receives new content to replace the content already played. Thus, the content on the player is immediately removed and replaced with new content from the content server upon the completion of content being played, resulting in the maximum amount of un-played or fresh content on the player at any given time.

In another embodiment, the player operates a general purpose data processor to execute an object program with:

(a) a control interface utilizing either the wireless interface or the docking connector interface to exchange data with a remote computer, resulting in external control and management of the player so that the player can be remotely controlled to initiate the play of content, stop the play of content, select new content or initiate any other event that can be performed manually utilizing the keypad,

(b) an object controlling utilization of the wireless interface to exchange data with a compatible similar remote player, resulting in external control and management of the remote player so that the remote player can be remotely controlled to initiate the play of content, stop the play of content, select new content or initiate any other event that can be performed manually utilizing the keypad, and

(c) an object controlling utilization of the wireless interface to exchange data with a substantially similar remote player resulting in the sharing, trading or vending of digital content whereby the content from one player can be moved or exchanged with the content of a remote player.

In a further embodiment, the player operates a general purpose data processor to execute an object program for non-volatile memory management, which uses a content priority in metadata associated with the content to determine which content can be replaced for storage required for recording or downloading new content, whereby a voice message can be recorded on the player and the digital audio content can be stored by removing digital content on the player with a priority less than the priority of voice content.

In a further embodiment, the player operates a general purpose data processor to execute an object program to provide means to histogram content usage and report the results to the content server to record and analyze, resulting in the recognition of content usage patterns usable by a content server with a play list manager software program to recognize the most frequently played content and that content which was most frequently skipped or not played and to determine which content the user most likely prefers to listen to, resulting in that content being downloaded more frequently. This player also provides means to modify the user preferences associated with content, resulting in the preferences being uploaded to the content server play list manager software program upon next content download, whereby the user can change via the player the frequency or type of content that is downloaded to the player in the future.

In a still further embodiment, the player has software to operate a general purpose data processor to execute an object program for disabling certain hardware circuitry to reduce the functionality of the player with the benefit of reduced power consumption. Thus, when not in use, the player can be put into a standby state minimizing power usage while not losing the context and state of the player and while minimizing the time required for resumption of normal use.

In still another embodiment, the player has software to operate a general purpose data processor to execute an object program wherein a digital content update can be performed from outside the content server network and through the network firewall, whereby the player can perform content updates from outside its home network by retrieving content from the home network.

In one embodiment, the player includes an electrical voltage monitor and uses software to implement a process of operating a general purpose data processor to execute an object:

(a) providing for the player to have at least three states, those states being an active state, a standby state and an inactive state, wherein the active state means the player is on, ready for use and able to play digital content, the standby state means the player is in a state of reduced functionality but still monitoring input voltage and the inactive state meaning the player has been fully disabled and is non functional;

(b) performing continuous monitoring of the docking connector interface and the dash connector interface power source voltage to compare that to a predetermined voltage level indicative of an active vehicle charging system and if the source voltage is greater than the predetermined voltage it results in a state change of said player from the standby state to the active state, whereby if the vehicle is started and the vehicle charging system activated, the state of said player is changed from the standby state to the active state,

(c) performing continuous monitoring of the docking connector interface and the dash connector interface power source voltage to compare that to a predetermined voltage level indicative of an inactive vehicle charging system, and if the source voltage is less than the predetermined voltage it results in a state change of said player from the active state to the standby state, whereby if the vehicle is turned off and the vehicle charging system deactivated, the state of said player is changed from the active state to the standby state, and

(d) performing continuous monitoring of the docking connector interface and the dash connector interface power source voltage to compare that to a predetermined voltage level indicative of the power source battery wearing down below normal operating levels, and if the source voltage is less than the predetermined voltage it results in a state change of said player from the active state or standby state to the inactive state, whereby if the vehicle battery is wearing down below normal functional levels the state of said player is changed from the active state or the standby state to the inactive state.

In another embodiment, the player has software to operate a general purpose data processor to execute an object program wherein the wireless radio transmitter is disabled by means recognizing headphones have been inserted into the stereo headphone jack and whereby the insertion of headphones into the stereo headphone jack disables the FM transmitter to reduce the power consumption of the player during headphone usage.

In one embodiment, the player has software to operate a general purpose data processor to execute an object program wherein user preferences on a remote computer are downloaded and used as user preferences for the player, to simplify the process of setting user preferences on said player with the use of a software program installed on the remote computer providing a nicer and easier to use interface for setting preferences.

In one embodiment, the player has software to operate a general purpose data processor to execute an object program that provides vehicle maintenance recording and reporting functions, whereby the player can store and retrieve information about the vehicle maintenance like oil changes, tire rotation and other similar activities.

In one embodiment, the player has software to operate a general purpose data processor to execute an object program that provides radio frequency content reception recording initiated manually via the player user interface on demand or initiated automatically based on a predetermined schedule downloaded onto the player whereby the user can have radio frequency content played at one time recorded and played back at a later time at their convenience.

### Interfaces

Referring to FIGS. 1-6, the present invention has an on/off button interface 1, an LCD graphical display interface 2, a stereo headphone jack interface 3, a memory slot interface 4, a keypad 5, a microphone interface 6, a docking connector interface 7, a dash connector interface 8 with dash connector contacts 9, a speaker 10, and a reset switch 11. Referring also to FIGS. 7-10, associated with the player 20 are a power cord wire 12, with a docking connector interface 13, a 12-volt accessory adapter 14, and a power adapter stereo headphone jack 15. Within the player 20 are an internal wireless FM transmitter 30 and a wireless transceiver interface 50. Each of these interfaces and other features are described in more detail below.

### Functional Component Overview

FIG. 10 provides a schematic block diagram showing the player 20 of FIGS. 1-6, with a base personal computer 110 acting as a content server or content source for remote player 20. Also shown are a second, peer player 220, as well as the environment in which the players 20, 220 and the base PC 110 operate. The base PC 110 may be a conventional Wintel or Apple computer, including a CPU and display 120, a keyboard 116 and a hard disk or similar secondary storage 112 and further including server software 1300 and a wireless transceiver 150, preferably based on the Wi-Fi standard. To access content, the base PC 110 will have a link to the Internet 160, where it may communicate with one or more Internet content providers 162.

The player 20 has a CPU 52, which may be a general-purpose microprocessor with RAM. For secondary memory it may have flash memory 60 and (for greater storage) a hard disk 62. Included in the software components 1350 that may be present on the player 20 is an MP3 player for music playback and several other software components for managing files on all storage media addressable by the player and performing the PDA and other functions discussed above and below. Also part of the player 20 is the FM transmitter 30 covering the standard FM broadcast band and capable of short-range transmissions of FM-modulated music playback signals to a nearby FM receiver 100, as further described below. The player further has a receiver 40 for the standard FM broadcast band (which may be expanded to receive AM, VHF or other terrestrial or satellite broadcast signals).

Communication between the player 20 and the base PC 110 occurs by means of a wireless transceiver 50, permitting the formation of a wireless link 114 for communication between the transceivers 50 and 150 using Wi-Fi or a similar standard protocol. Another mode of communication to and from the player 20 occurs over the player's VPN facility 54, which may be used to make a connection 119 to the Internet.

Associated with the player 20 is a vehicle dock 17 for use when the player 20 is in a vehicle and using the vehicle's battery as a source voltage, with an associated power sensor/state switch 24 in the player whose function is described below. There is also a desktop dock 28 for use when the player 20 is to be connected directly to the base PC 110 by wired link 115, using docking connector interface 7. A battery/recharger unit 56 provides power for the player 20.

The peer player 220 has essentially the same components and facilities as player 20, although for simplicity not all its details are shown. It has a CPU 252, which may be a general-purpose microprocessor with RAM. For secondary memory it may have flash memory 260 and a hard disk 262. included in the software components 1350 that may be present on the player 220 is an MP3 player for music playback and several other software components for managing files on all storage media addressable by the player and performing the PDA and other functions discussed above and below. Player 220 has a wireless transceiver 250 for a Wi-Fi communications link to a peer unit such as player 20 or to its own base PC, not shown. The peer player 220 also has a VPN facility 254, which may be used to make a connection to the Internet and a batter/recharger unit 256.

### OPERATION OF PRESENT INVENTION

The player 20 comfortably fits in the average sized hand. Its shape as shown in FIG. 3 allows for a display panel 2 that is larger than the base of the unit, which is smaller to accommodate the hand. The shape is not symmetrical to give it character and to differentiate it aesthetically from the other players on the market. Physically, the player 20 is formed from a front panel 26 joined to a back panel 22 at a connection seam 24.

### Docking Connector Interface

The docking connector interface 7 provides a convenient and multipurpose connector interface. The connector 7 is recessed into the seam 24 of the player 20 to mate with a desktop docking station 28 as well as a power cord connector 13. The docking connector interface 7 provides an electrical interface to provide power to the player 20 for operation, battery charging, wired digital content download, wired digital content uploads, analog content output, digital content output and an electronic external control. The electronic external control portion of the interface provides an interface to the player 20 enabling the player to be fully controlled and managed from an external computing system such as base personal computer 110. The electronic external control provides a means to fully control the player 20 by allowing all user functions that can be performed via the physical user interface keypad 5 to be done remotely from the external computer 110 via the docking connector interface 7.

### Dash Connector Interface

The dash connector interface 8 on the back panel 22 provides a second convenient and multipurpose connector interface to the player 20. This connector interface is formed into the back of the player to mate with a vehicle dash mount 17. The dash mount 17 is an easily installed mount (using dash mount adhesive 16) that provides both stability and electrical connections to the player 20 when inserted and connected. The dash connector 8 provides via dash mount electrical contacts 18 the same capabilities as the docking connector interface 7 described above, however it provides a means to attach the player 20 to the dashboard of a vehicle from the rear of the player 20, minimizing the overall footprint while adding stability to the player.

### Stereo Headphone Jack Interface

The player 20 has an analog headphone jack interface 3. Audio content is output to the headphone jack. A sensor means 21 is provided to detect the insertion and removal of the headphone jack so that by default the FM transmitter output 30 is disabled when the headphones are plugged in and enabled when the headphones are taken out.

### Memory Slot Interface

This player 20 contains a plurality of memory slot interfaces 4 (for simplicity, FIG. 4 shows only one) that enable the use of removable memory cards. These slots can be either functional or non-functional, where the card data storage in the functional card slots is accessible by the processor 52 and the card data storage in the non-functional slots is not accessible by the processor 52 of the player, but the slot is simply there for additional low-cost offline card storage.

### FM Transmitter Interface

The player 20 contains an internal FM transmitter 30, not shown in FIGS. 1-6, since it is entirely internal to the player 20, but shown schematically in FIG. 10. The transmitter 30 provides the capability to transmit through the full spectrum of the FM band, from 88 kHz to 108 kHz. A means to electronically control the transmit frequency is integrated into the player 20 such that it can be controlled via the keypad 5 or through the external control interfaces using either the wireless or wired interfaces. The internal FM transmitter 30 eliminates the need for external accessories or wires to interconnect the player to external stereo receivers for content playback, thus eliminating powering the external accessories, the connecting of the accessory to the player 20, turning the accessory on and off, and carrying and storing the external accessory. The prior art players utilize external accessories to achieve this. It is well known that the drawbacks of using these accessories include the inconvenience of having to carry the extra accessory, attaching it prior to use, detaching it after use, turning it on, turning it off, and having separate power for them.

As an additional feature, the FM transmitter may use the encoder software 1390 (FIG. 1390) to access text associated with content and transmit the text using RDS or a similar embedded text technology for display on any receiver set up to receive the transmitted music content and decode this associated text information.

The transmitter 30 complies with applicable FCC or other regulations for short range transmission, to help avoid interference with receivers other than those intended to receive content playback.

### FM Receiver Interface

The present invention contains an internal FM receiver 40, not shown in FIGS. 1-6 since it is entirely internal to the device 20. Although a standard FM receiver is not unique to digital content players, the use of it in this player is. The FM receiver 40 is used for FM band radio reception for the user's listening pleasure (allowing real time or near real time playback or providing content stored for later playback), but it also plays an important role in providing quality FM transmission to an external FM receiver 100. The digital tuning means of the receiver 40 are used to monitor and scan the signal strength of all FM frequencies in the FM band to identify and report the best or a suitable FM frequency for transmission use by FM transmitter 30 with the least amount of signal interference. A frequency selection program component may execute on CPU 50 to control scanning and the best frequency finding and selection process. The best frequency is characterized by the frequency that has the lowest signal strength. Optimizations for choosing the best or a suitable frequency can be performed by the integrated software program component to choose alternatively those frequencies that are also adjacent to other low signal strength frequencies, frequencies that have the best history of having low signal strength, through the use of histogram analysis, and weighting the selection to the use of frequencies that are most suitable for low power transmission.

The best frequency selection can be initiated manually via user interaction or automatically and repetitively via program control. If the user determines a new frequency is desired, they can initiate the best frequency search. The result of the search will be displayed on the liquid crystal display for the user to read and to set their receiver to the appropriate channel. Alternatively, the best frequency scan can be initiated automatically by program control. In this scenario, if a better frequency is found, it is displayed on the LCD for the user to confirm a change. If not confirmed, the frequency will stay the same. If the better frequency is only marginally better, or such that it will not result in a substantially better reception, the scan will end without a report to the user. An optimization to this scan is to cancel the scan if the current frequency is at acceptable signal strength levels.

FIG. 11 shows a flowchart of the logic of the transmit signal selection software component. At 1102 the component monitors for a request to scan for a new “best” transmit frequency. At 1104, the component checks for a manually initiated request to perform a scan. If none is present, the component checks at 1106 for a program-initiated scan. If none is present, the component returns to the monitoring state at 1102. If either a manually initiated request or a program-initiated request is present, then at step 1108, the component scans the available frequency range for interfering signals. After traversing the available range, at 1110 the component selects and stores the least interfering signal. At 1112 the component applies alternative frequency selection methods, selecting frequencies that are also adjacent to other low signal strength frequencies, frequencies that have the best history of having low signal strength, selecting frequencies through the use of histogram analysis, and weighting the selection to the use of frequencies that are most suitable for low power transmission. After applying these methods, at 1114 the component again selects and stores a proposed “best” frequency based on the alternative methods. At 1115, the component checks to see whether the frequencies found are no better that the current frequency and/or whether the current frequency is acceptable. If so, the scan and change frequency operation is ended without further action. Otherwise, the component proceeds to step 1116.

At 1116, the component displays the proposed frequency with the least interfering signal 1118. At 1118, if the user selects this proposed frequency, then at 1120 the component resets the FM transmit frequency and displays a reminder to tune the applicable receivers to the new frequency. If at 1118 the user does not select the proposed frequency, then at 1122, the component display the best frequency as determined by the alternate methods. At 1124, if the user selects this proposed frequency, then again at 1120 the component resets the FM transmit frequency and displays a reminder to tune the applicable receivers to the new frequency. If at 1124, the user does not select the proposed frequency, then at 1128 the component displays a message reporting continuing usage of the current transmit frequency. It will be seen that the frequency selection method could also be used for transmissions other than FM, where a suitable receiver to test for interfering signals is present.

### Wireless Transceiver Interface

The present invention integrates a wireless transceiver interface, not shown in FIGS. 1-6, since it is entirely enclosed in the casing, but shown schematically in the block diagram of FIG. 10. The player's wireless interface 50 (which may be implemented using Wi-Fi or other similar wireless protocols and supporting hardware) enables an electronic wireless interface/link 114 between the player 20 and the content server 110 or another peer player 220 (each having a corresponding wireless transceiver) without the use of a physical cable or line of sight access (for an optical link). The wireless interface 50 can be used to provide all of the interconnection features of the wired interfaces with the exception of power.

This wireless interface 50 provides a considerable advantage in player usability. It is commonly known that one of the more common complaints of digital content player users is the laborious process for getting new content onto the player. Prior art requires the user bring the player 20 to the content server PC 110, turn it on, attach a cable, initiate a content download, wait for the download to complete and then detach the cable. This process is labor-intensive, time-consuming and requires relocating to the location of the content server. The integration and use of a wireless interconnect into the player totally eliminates this undesirable process. With a wireless interface, the process of putting new content onto the player can be fully automated, eliminating the need to bring the player to the content server, attach a cable, initiate the content download, wait for the download to complete and detach the cable. Instead, all that is necessary to download content to the present player 20 is to have the player 20 turned on and in range of the wireless transceiver 150 connected to the content server 110. Thus, the download may occur when the user parks a vehicle in which the player 20 is mounted, or simply places the player 20, in transceiver link proximity with the content server 110.

Another significant feature enabled with the wireless interconnect is the ability to download time sensitive content to the player 20 on a consistent, recurring and predetermined basis. For example, the content server 110 is able to download or record content from the Internet 160 based on the user's preferences as stored on the server 110. The wireless interface link 114 allows for the automatic and recurring download of this content to the player 20 on a user-defined timeline, expressed as part of stored user preferences. This enables a user to record and/or download content from one part of the country or world onto the content server 110 and then download it to the player 20 each day prior to the start of the day. This enables the user to listen to this personalized content daily without having to perform any manual day to day content downloads.

Another significant feature enabled with the wireless interconnect link 114 is the ability to subscribe to a Internet content provider service and have the content automatically downloaded onto the player on a daily basis. This closely resembles the XM Satellite service, but it allows the user to have more control over what content they listen to, when they want to listen to it, and the ability to replay or to skip songs of their choice.

### Graphic Display Interface

The player 20 of the present invention has a graphical liquid crystal display interface 2 for a user interface viewer.

### Speaker Interface

The player 20 of the present invention has a built-in speaker 10 for use as audio output, creating beeps and other audio control alerts as well as an output speaker to play audio content.

### Microphone Interface

The present invention has a microphone interface 6 to record audio content and store it digitally on the player. This may be part of a set of PDA functions implemented in software on the player 20 and running on the CPU 52.

### On/Off Momentary Switch Interface

The present invention has a momentary on/off switch 1, whose state is monitored by processor 52. This switch is multi-functional, whereby a one second momentary push puts the player into and out of a standby state and a greater than two second continuous push puts the player into and out of a power off state.

### Reset Button

The present invention has a reset button 11 to reset the player's microprocessor 52 and operating system when the player 20 is not functioning properly.

### Power Adapter Headphone Jack Interface

The power adapter headphone jack interface is used to extract audio output from the player 20, via the power accessory cord 12 (FIG. 7) to the power accessory adapter 14 and to the power adapter headphone jack interface 15. This allows the user to extract audio from the player 20 and provide power to the player 20 with one electrical cord and connector 13, thus eliminating the need for a second cord.

### Player Features and Functionality

The present invention has unique features and functionality that enhance the usability of the player and differentiates it from other digital content players as described below.

### Use of Digital Audio Content for Help and User Alerts

The present invention utilizes its digital audio content playing capability for use as an audible user help and support interface, making the player 20 easier to use. To assist in the operation of the player, digital audio content stored on the player 20 is accessible for user help. This may be stored in the hard drive 62 or flash memory 60 or other memory addressable by the CPU 52.

### Content Management

The present invention has several content management features to significantly enhance the usability of the player 20. A play list manager software program 1300 that runs on an external computer, called the content server 110, manages the content on the player 20. The program, which is provided with the player 20, manages the digital content on the computer 110 and downloads content to the player 20. The content downloaded to the player 20 is selected by the play-list manager program 1300, based on preferences set by the user. The play list manager program 1300 includes a scheduler enabling it to download content automatically and based on user preferences.

These features require the use of the player20, its software and the play list manager software 1300 that comes with the player. These features are described in the following paragraphs. However, before describing these, it is useful to provide some examples of possible structures for a content file and to lay out the general types of components or objects that might be used to manage content files and make them available for play.

FIG. 12 shows by way of example three possible items in a content file 1200 that might be stored on player 20. Item 1210 is a music content file. The actual music content data is at 1219. Associated with the content data 1219 is metadata, which in field 1212 may include a file ID, the title and artist, and the musical genre. Other metadata in field 1212 may include a value designating that this file is member of a particular playlist and further may include digital rights management (DRM) information. In field 1214 is metadata that might be used to guide replacement of this content, such as an expiration date and/or time. In field 1216 is metadata that might be useful for content management or of user interest, such as keywords, e.g., album title, the first few words of any lyrics, which might be provided with the content as delivered. In field 1218 is additional metadata, which may be added by the user.

The item 1220 is a video content file. The actual video content data is at 1229. Associated with the content data 1229 is metadata, which in field 1222 may include a file ID, the title and director, and the movie cast. Other metadata in field 1222 may include DRM (Digital rights management) information. In field 1224 is metadata that might be used to guide replacement of this content, such as an expiration date and/or time. In field 1226 is metadata, such as keywords, e.g., excerpts from reviews or dialog, which might be provided with the content as delivered or additional metadata, which may be added by the user.

The item 1230 is a file that may comprise a data made or used as part of PDA functions. The actual PDA file content data is at 1239. Associated with the content data 1239 are metadata, which in field 1232 may include a file ID, a PDA file name and format, such as voice recording or text, which might be audio user help, a calendar entry, and/or a spreadsheet, which might contain vehicle service records. In field 1234 is additional metadata that might be used to manage the PDA file, such as security data or an expiration date and/or time.

FIG. 13 shows an example of a possible set of components or objects used by the content server 110 and the player 20 in their operational interaction. The contiguous blocks at the top of FIG. 13 are components 1300 of the server software, together with the content files 1326 maintained on the server 110. The contiguous blocks at the bottom of FIG. 13 are components 1350 of the player software, together with the content files 1200 maintained on the player 20.

The components of significance for further explanation of the content server software 1300 are:

User content preferences 1310: a component for accepting and storing preferences a user may specify for music or other content the user wishes to have downloaded, the frequency of downloading and/or replacement, and other factors permitting the user to shape what is available from day to day on the player 20.

Content management 1320: a component that locates (on the Internet or in local files) and supervises the initial downloading, the storage and the player downloading of the content files 1326 responsive to user content preferences, including storage of metadata associated with the content files and receiving user-specified metadata for association with content files, both of which may be used for file location. File location, storage and downloading follow time schedules specified in user preferences.

Usage file and analysis component 1322: a component that tracks files downloaded, receives usage file data and usage data analysis from the player 20 to perform further analysis, modify user content preferences in response to usage data and its analysis and provide a basis for content downloading and/or file replacement that is responsive to actual content use on the player 20.

DRM control 1324: this component provides digital rights management for content on the server that has associated DRM data.

Transmission link control 1330: a component that enables Wi-Fi or other standard communication protocol wireless communication via link 114 between the server 110 and the player 20. The content management component 1320 uses this to exchange control information, content files or other data with the player 20.

Internet connection 1332: a component that uses a browser or other standard software to execute requests to find content specified by the user in user preferences as obtainable on the Internet 160.

The components of significance for further explanation of the player software 1350 are:

User content preferences 1360: a component for accepting and storing preferences a user may specify for music or other content the user wishes to have downloaded, the frequency of downloading and/or replacement, and other factors permitting the user to shape what is available from day to day on the player. These user preferences, after acceptance in the form of input at the player 20, are communicated to the content server 110 to guide content downloading. Communication may be by the wireless link 114 or Internet connection.

Content management 1370: a component that locates and supervises the storage of the content files 1200 on the player responsive to user content preferences, including storage of metadata associated with the content files and receiving user-specified metadata for association with content files.

Usage file and analysis component 1372: a component that tracks files downloaded, accumulates usage file data as content is actually used or skipped and to perform basic usage analysis. The usage file data and analysis are configured for communication to and analysis by the server 110 to provide a basis for content downloading that is responsive to actual content use on the player 20.

DRM control 1374: this component provides digital rights management for content on the player that has associated DRM data.

Transmission link control 1380: a component that enables Wi-Fi or other standard communication protocol wireless communication via link 114 between the server 110 and the player 20. The content management component 1370 uses this to exchange control information, content files or other data with the server 110.

Internet connection 1382: a component that uses a browser or other standard software to execute requests to connect to the Internet, e.g., by VPN.

Encoder: a component for accessing, encoding and transmitting selected metadata in digital form as part of signal from the FM transmitter 30, so that textual data can be received at FM receiver 100. The encoder preferably operates using the RDS standard or an equivalent.

PDA Functions: this suite of components provides PDA type functions.

Partitioned content files 1200: the storage areas 1200a, 1200b . . . 1200n are file storage areas on the content server defined by partitions of particular size, so as to permit the user via the content management component 1370 to select how the storage resources are used when the player's storage encounters limits.

### Stale Content Refresh

Stale content refresh provides for manual or automatic content replacement for all stale content, where stale content is content stored on the player 20 that has been played one or more times since downloading or player content that doesn't meet the criteria for the content scheduled for download to the player. A stale content refresh replaces all of the stale content on the player 20.

### Continuous Content Caching

Continuous content caching is a method of replacing stored digital content on the player 20 immediately after content is played and while the player is in contact with the content server 110. This feature is similar to content streaming except it keeps the storage on the player 20 fresh with un-played content. This ensures the player 20 has the maximum amount of fresh content on the player 20, allowing for the play of fresh content even while the content server is down or the wireless connection is poor.

### Virtual Private Music

The player 20 provides a Virtual Private Music feature enabling the player to access the home content server 110 using an Internet connection. Providing the content server 110 is attached to the Internet and enabled with Virtual Private Network software 54, the player 20 with its integrated Virtual Private Network software can initiate a content update from any Internet connection. This enables the user to get access to their content from anywhere they have Internet access.

### Temporal Content Replacement

Temporal Content Replacement provides for special treatment of time sensitive content. Content is identified as temporal using tags in the content metadata to identify the temporal content and the associated expiration date. The content becomes stale once played or after the expiration date passes, thus will be replaced during the next content update.

### Memory Management

Referring again to FIGS. 12 and 13, the player 20 implements a memory content management system as part of the player software that enables the player 20 to most effectively use its non-volatile memory. The memory management system 1370 allows the user to allocate portions of the accessible player memory 1200 to be allocated for specific purposes and content type. For example, the user could define partitions 1200a, 1200b, . . . 1200n with (respectively) 20% of the memory to be used for voice recording, 30% for playlist 1 and the remaining for another playlist. The allocation can be strictly limited to the defined content or allocated on a provisional basis subject to a storage need with higher priority. This provides user control of how the memory on the player 20 is used for content storage. Utilizing automatic content update functionality, this can be used to determine what percentage of the memory is allocated for content of each playlist. The allocation of the memory can be done via either the player 20 or the play list manager software 1300 on the content server 110.

### Voice Recording Content Management

The voice recording memory content management feature of content management component 1370 optimizes the usage of the player's non-volatile memory when the player 20 is used in combination with the voice-recording feature. Voice recorder content management allows for the removal of digital audio content for the use of voice storage and providing the user the ability to specify the maximum amount of storage that can be used for recorded voice. When that memory is not being utilized by voice storage, it is available for use by other types of content storage. During a content download, the unused content storage allocated for voice can be used for digital content, and then later replaced with voice content as needed.

### Player Initiated Content Downloads

The player 20 provides for Player Initiated Content Downloads. This allows the user to initiate new content downloads from the player user interface without having physical access to the content server. This feature can be used in conjunction with the virtual private network feature 54 to achieve player initiated content downloads via the Internet.

### Content Recording

The player 20 provides a means to record audio content using internal receivers 40, whether that be AM, FM or Satellite, by manually starting the record process or by an automated process of defining a recording schedule and having the player record the content and store it in digital storage. The automated process uses a recording schedule that can be created on the player or downloaded to the player 20 from an external device like base computer 110, which allows for a more user-friendly user interface. The recording schedule is downloaded to the player 20 as a content update stored in memory 60, 62 ensuring the recording schedule is updated as needed.

### Vehicle Use Features

The present invention virtually eliminates the traditional vehicle installation process by eliminating the need to wire it to the ignition switch, ground the player, connect audio output wires to the stereo system, and remove and replace the factory stereo system. However, unlike existing portable players, this player functions with the normal and expected behavior of an in-dash vehicle player. The normal and expected behavior includes the player 20 turns on when the vehicle is started, and the player goes off when the vehicle is turned off.

To eliminate hard wiring of the player to the vehicle, the player 20 uses a 12 v accessory adapter plug (see FIGS. 7-9) for a supplemental power source to derive operating power from the vehicle's electrical system. To achieve the normal and expected behavior, the player 20 monitors, e.g., at power sensor/state switch 24 (FIG. 10), the voltage of the power source to detect the status of the engine, either on or off. When the player 20 is in the active state, meaning the player is functional and ready to play content, it monitors the input voltage looking for a drop below a predetermined level, suggesting the alternator is no longer charging, thus the engine is off. When this is detected, the player 20 enters the standby state, which is a low power consumption state that still has the ability to monitor the input voltage. When in this state, if the voltage level rises above a predetermined level for a predetermined length of time, suggesting the engine is running and the alternator is charging, the player state is changed to the active play state, and the player begins playing content again. When in the standby state, the player may receive control signals over the transceiver link 114 that activate the player to an on-state for a scheduled download event under control of the server software 1300.

To prevent battery drain, when the input voltage drops to a predetermined level suggesting the battery is low and wearing down, the player shuts itself down and enters the powered down state. The preceding functionality may be implemented in software linked to power sensor/state switch 24.

### Content Priority Management

The present invention provides content play management enabling the user to define preferences and policies associated with content to determine the type of content and the frequency of which content is downloaded to the player 20. The policy is user programmable based on the user's own preferences. The user preferences can be defined using any combination of content attributes to specify the user's preferences. Content attributes can be either predefined by the content vendor or can be defined and added by the user and stored with the content as metadata (see FIG. 12 and accompanying text). User preferences can be used in conjunction with content attributes to determine the type of content downloaded, the frequency content is downloaded and the duration the content is stored. A scheduling function can be performed to allow the user to download content based on days of the week, number of days per month or whatever schedule is desired for the content program download schedule.

The attributes associated with the content can be modified by the user on either the content server 110 using the play list manager software 1300 or by the user on the player 20. Changes made on the player 20 to the content attributes will be reconciled with the content server 110 during content updates. This allows the user to change the frequency or any other attribute for content on the player and have the changes recorded on the content server play list manager program.

### Content Histogram Recording and Analysis

Using histogram techniques, the player 20 tracks the frequency of content play to automate a method of determining the user's preference for content. The information is recorded, stored and returned to the content server play list manager program 1300 for record keeping. Information regarding the use of digital content on the player is recorded, like the number of times content was played, played to completion and played without completion. Content played more frequently can be downloaded more frequently whereas content that is continuously skipped or interrupted during play can be downloaded less frequently. The usage file data and accompanying analysis are implemented in usage file and analysis component 1372 (see FIG. 12) on the player 20.

### Calendar and Schedule with Audio Alarm

The present invention includes a calendar, personal contacts and meeting scheduler utility implemented in PDA functions component 1392. This utility supports the download of Microsoft Outlook Contacts and Calendar content. To alert the user of a scheduled event, the player will notify the user with an audible sound via the internal speaker 10 as well as playing a digital audio message over all active audio outputs announcing the calendar event. This notification alarm stops the play of the current content and replaces it with an alert notification audio clip.

### Vehicle Maintenance Recorder and Viewer

This player includes a vehicle maintenance recorder and viewer also implemented in PDA function component 1392. It provides a method to record and view useful vehicle maintenance records including the date and-mileage of oil changes, lubrications, tire maintenance as well as other vehicle events. The maintenance activities can be stored and retrieved from the player 20 (see PDA content file, FIG. 12 at 1230) and are also uploaded onto the content server 110 for backup and server side access purposes.

### Peer to Peer Content Sharing

The present invention, utilizing radio frequency transmission capability, provides peer-to-peer content sharing. Using the wireless interface 50, the player 20 enables a plurality of users to negotiate, communicate and trade digital content. Each user first establishes a trading session with a trading partner. Once the session is established between trading partners, each partner identifies the digital content they are willing to trade in a transaction. If both parties agree, the player 20 or 220 exchanges the content via the wireless interface. Such sharing or using a peer as a content source may be under the control of DRM control component 1374.

### Packetized Wireless Remote Control

The present invention uses both wired and wireless transports with packetized data networking as a connection interface between the player 20 and the content server 110 or one player and another player. Utilizing the networking interface, the player is able to connect to and interact with a plurality of other players or content servers. These interfaces enable downloads and uploads of digital content between the content server 110 and the player 20 with or without the use of physical wires, and electronic control interface to fully and remotely control either the player from the content server or the content servers from any player.

### Conclusion, Ramifications and Scope

The preferred embodiment of the present invention is a wireless handheld portable digital content player small enough to comfortably hold in one hand but large enough to have a sufficient liquid crystal display for viewing and a reasonable size keypad for thumb or finger navigation and key stroke entries.

The player is convenient for use not only as a portable player, but also for use in a vehicle, home and work. It works seamlessly in a vehicle with the auto-on and auto-off features eliminating the need to turn the player on and off manually upon entering and exiting the car. It's convenient for use in a vehicle since no external accessories or wires are required to connect it to the in-vehicle stereo, with the use of the internal FM transmitter.

The player is the most convenient digital content to use because the most laborious task of updating digital content of the player is done automatically and without user intervention. This enables the use of less storage while getting the benefits of more storage, having fresh content to listen to every day.

The automated and wireless content updates are better than having lots of storage, since new content on the content server is automatically moved onto the player without manual intervention or physical contact with the content server. Additionally using wireless hotspots, wireless access points open to public or subscribers, a user can be receiving new content almost continuously, moving from one hotspot to the next, receiving broadband content.

The automated and wireless content updates are better than having lots of storage, since time sensitive content (news, sports and weather) can be downloaded to the player automatically and recurringly without manual intervention or without physical contact with the content server.

The player effectively works in a home stereo environment utilizing the wireless stream to cache feature, enabling the on-player storage to be continuously filled with fresh (unlistened to) content. This allows the player to be used even if the content server is down or the wireless connection to the player is disturbed.

The internal FM receiver and scanner make it easy for the user to find the best FM frequency to transmit over, resulting in the best quality FM transmission and reception.

The integrated FM transmitter enables the player to be conveniently used in a vehicle without the time consuming and costly installation of fixed players while utilizing the vehicle's stereo system for audio output. This no-install feature enables consumer to purchase the player on an impulse, something seldom done with players that require installation.

This player allows the consumer to purchase it and use it in their vehicle on the way home from the retailer.

The integrated FM transmitter eliminates the use of external accessories to connect to external receivers, eliminating the storage, connection and operation of the accessory in addition to the player.

The integrated FM transmitter along with the integrated FM receiver provides for the “best frequency” channel selection and automatic FM transmit capability, minimizing the effort required of the user.

The portable player with integrated FM transmitter allows the user to use the player in one vehicle without any installation and simply move to another vehicle without uninstalling the player and further moving into work or home again without installation but with effective use of the player in all environments.

The player provides a removable nonvolatile memory slot for SD Non-volatile Cards but additionally provides nonfunctional slots for the storage of additional cards.

The player's docking port interface allows for the connection of either a power cord (with optional analog and digital audio out) or a desktop docking station. The docking station provides for several enhanced functions including an analog out jack, a digital out jack, a USB interface, a power cord as well as other connections. This allows the user to simply insert the player into the docking station and enjoy fixed connections to several other players without having to plug each in individually.

The unit's stereo headphone jack is used for a headphone interface, but also performs another function. By default, the FM transmitter is disabled when the headphone jack is plugged in. Presumably, when the headphone jack is plugged in, the user is listening via the headphones and turning off the FM transmitter saves battery power. This feature can be disabled by user preferences.

The player comes with content server software that includes a play list manager, content download functionality, programmable time and event based content download scheduler and a user preferences configurator. The programmable time and event based content download scheduler enables content download to take place based on user preferences using either date/time or recognizable events (such as player coming into contact with the content server) to initiate content downloads.

The present invention provides content play management enabling the user to define preferences and policies associated with content to determine the type of content and the frequency at which content is downloaded to the player. Content can be downloaded based on a schedule or based on frequency or whatever the user desires regarding the type and frequency of content downloaded to the player. Changes to the content attributes can be performed on the player to adjust future download operations.

Using histogram recording and analysis, content played on the player most frequently can be downloaded more frequently whereas content that is continuously skipped or interrupted during play can be downloaded less frequently, intending to match the user's historical play preferences with future player content downloads.

Because of the complexity and large number of features supported by the player, it can be challenging to remember how to use all of the features. To support the user in this capacity, the player uses audio and video output to provide on-player help. The help comes in two formats, either video or audio or both together.

Content is manually or automatically downloaded to the player based on user preferences set up on the content server. User preferences can be associated with any digital content file to be used in the determination of what content to download to the player.

A “Stale Content Refresh” feature enables a content update to be performed such that only the stale content, that content which has already been played since downloaded to the player, to be removed and replaced with new content, minimizing the amount of new content downloaded (which saves time) and allowing the user to listen to the music downloaded but not yet played.

Player memory management allows for the most effective use of storage by allowing all of the available content storage to be used for digital content, being removed and replaced by higher priority content like computer files or recorded voice. Priorities can be assigned to content types including computer files, digital audio, recorded voice audio, etc. This eliminates the need to dedicate memory for storage of content that may or may not exist.

The player includes a dash connector interface used to attach the player to a vehicle dash providing a one step attachment and detachment which provides power to the player, wired analog and digital audio output and wireless audio output when docked. The docking connect also provides for horizontal and vertical movement to adjust the player to face the user.

The player provides a time shifting mechanism that allows the user to manually or automatically based on a predetermined schedule, record content for later playback. This allows the user to listen to content broadcast at one time and listen to it at another time based on their individual preference. Content can be recorded by the player and stored on the player, or content can be recorded on a computer utilizing the play list manager software and downloaded to the player.

### Preferred Embodiments

The preferred embodiment of this invention is a portable handheld wireless digital content player.

### Other Embodiments

Other embodiments that are viable for use include:

(a) fixed in dash vehicle player,

(b) fixed under dash vehicle player,

(c) fixed trunk mount vehicle player,

(d) portable handheld player with detachable components,

(e) a fixed component of another player,

(f) a removable component of another player,

(g) or a circuit of another player.

Although the subject invention has been described with reference to certain specific embodiments, persons skilled in the art will recognize that changes may be made in form and detail without departing from the spirit and scope of the invention.

What is claimed is:

1. A content server for delivering content to a remote player, comprising:
a transceiver link for communicating with the remote player;
a first program component for accepting user content preferences;
a second program component for locating content responsive to the user content preferences; and
a third program component for establishing communication with the remote player using the transceiver link and using such link for communicating one or more content files responsive to the user content preferences for storage on the remote player.

2. The content server of claim 1, wherein the transceiver link for communicating with the remote player comprises a wireless connection.

3. The content server of claim 1, wherein the transceiver link for communicating with the remote player comprises a wired connection.

4. The content server of claim 1, wherein the transceiver link for communicating with the remote player comprises a wireless local area network.

5. The content server of claim 1 in combination with the remote player, wherein the remote player is a multi-purpose player for use as two or more of: a portable, a vehicle, and a home digital content player.

6. The content server of claim 1, wherein the remote player and the transceiver link are adapted to use a broadband wireless network.

7. The content server of claim 1 in combination with the remote player, wherein the remote player further comprises an FM transmitter that transmits audio content from the remote player to an FM receiver.

8. The content server-remote player combination of claim 7, wherein the FM receiver is an FM receiver in at least one of a vehicle, a home or an office.

9. The content server-remote player combination of claim 7, wherein the remote player further comprises an FM band receiver adapted to scan an FM band and find for the FM transmitter an FM frequency suitable to transmit audio content.

10. The content server of claim 1, wherein the user content preferences comprise specification of one or more of the following:
a song title;
a playlist of song titles;
a genre associated with a content file;
an album title;
an artist; or
another item of metadata associated with a content file.

11. The content server of claim 1, wherein the user content preferences include a predetermined time schedule for communicating the one or more content files using the transceiver link to the remote player.

12. The content server of claim 1, wherein the user content preferences include a predetermined schedule that allows time shifting between when the content file is located and when the content file is listened to on the player.

13. The content server of claim 1, further comprising a fourth program component for managing content files, said fourth component adapted to store metadata associated with content files and to receive user-specified metadata for association with content files.

14. The content server of claim 1, wherein the remote player stores a usage file that tracks content playback and communicates the usage file to the content server.

15. The content server of claim 14, wherein the content server has stored user content preference information and the usage file is configured for analysis by the content server and for facilitating modification of the stored user content preferences in response to the usage file.

16. The content server of claim 15, wherein the usage file comprises information on the frequency of playback of content files, skipping of content files and failure to play content files to completion and the content server modifies the stored user content preferences in response to said information.

17. The content server of claim 14, wherein the usage file comprises information on when content has been played and the content server in response to receiving information on when content has been played modifies user preferences to provide for replacement of the content that has been played with content files newly transmitted to the remote player.

18. The content server of claim 1, further comprising an Internet connection component for connecting to the Internet for receiving updates to user preferences, said updates having been accepted as input at the player and being transmitted from the player via the Internet.

19. The content server of claim 1, wherein the second program component for locating content further comprises code for finding a content file in storage locally attached to the content server or in a website accessed by the content server.

20. The content server of claim 1, wherein the third program component becomes operable for transmitting a content file in response to a time schedule as specified in user preferences for recording of streamed content streamed at a specified time.

21. A player for storing and playing back media content received from a content source pursuant to stored user preferences, comprising:
a storage medium for storing media content for playback;
a transceiver link for communicating with the content source; and
a first instruction component for establishing communication with the content source using the transceiver link and using such link for downloading onto the storage medium one or more content files responsive to stored user content preferences.

22. The player of claim 21, wherein the player further comprises a first docking station connector used as two or more of: a wired content communication interface, a power charging interface, a digital content output interface, an analog content output interface, and an electronic control interface.

23. The player of claim 21, wherein the player further comprises a second docking station connector used for a vehicle docking connector with an analog content output, a digital content output and a power input.

24. The player of claim 21, wherein the player further comprises a rechargeable battery and battery charging circuitry.

25. The player of claim 21 wherein the player is configured to use as a content source one or more of the following: a personal computer, a peer player, or a website.

26. The player of claim 21, wherein the transceiver link comprises a wireless transceiver link.

27. The player of claim 21, wherein the transceiver link comprises a wired transceiver link.

28. The player of claim 21, wherein the transceiver link comprises a wireless local area network.

29. The player of claim 21, further comprising a second instruction component for managing content downloading, the second instruction component enabling a user to define for communication to a content source user content preferences based on one or more of the following:
a song title;
a playlist of song titles;
a genre associated with a content file;
an album title;
an artist; or
another item of metadata associated with a content file.

30. The player of claim 21, further comprising a second instruction component for managing content downloading, the second instruction component enabling a user to define for communication to a content source user content preferences specifying a schedule for when content is downloaded to the player.

31. The player of claim 21, wherein the player stores a usage file that tracks content playback and communicates the usage file to the content source.

32. The player of claim 31, wherein the content source has stored user content preference information and the usage file is configured for analysis by the content source and for facilitating modification of the stored user content preferences in response to the usage file.

33. The player of claim 31, wherein the usage file comprises information on the frequency of playback of content files, skipping of content files and failure to play content files to completion and the content source modifies the stored user content preferences in response to said information.

34. The player of claim 21, further comprising:
a playback device for creating a playback signal from the stored media content;
a playback transmitter for short range broadcast transmission of the playback signal modulated onto a broadcast signal; and
a frequency selector for surveying ambient broadcast transmissions and responsive to the ambient broadcast transmissions, selecting a broadcast signal frequency for the playback transmitter that reduces interference between the selected broadcast signal and the ambient broadcast transmissions.

35. The player of claim 34 wherein the playback signal is an audio signal and it is modulated onto an FM broadcast band signal.

36. The player of claim 34 wherein the frequency selector comprises a broadcast band receiver, said broadcast band receiver adapted also to provide music for realtime or near-realtime playing on the player or for processing and storing as a content file.

37. The player of claim 35 further comprising a headphone connecter and a sensor operatively connected to the headphone connector for inhibiting operation of the playback transmitter when a headphone is connected to the headphone connector.

38. The player of claim 34 further comprising an encoder and means for accessing text data in metadata associated with the stored media content and transmitting the text data for reception in coordination with the selected broadcast signal, wherein the encoder encodes according to RDS or equivalent.

39. The player of claim 21 further comprising an interface associated with the player for receiving user preference information and transmitting it via a wireless transceiver link to the content source.

40. The player of claim 21 further comprising a docking station with two or more of the following interfaces:
(a) a docking connector power interface,
(b) a docking connector analog audio interface,
(c) a docking connector digital audio interface,
(d) a docking connector universal serial bus interface,
(e) a docking connector data interface,
(f) a docking connector control interface,
wherein the player is easily mounted to and dismounted from the docking station providing power to the player via said docking connector power interface, analog audio output via said docking connector analog audio interface, digital audio output via said docking connector digital audio interface, a serial bus interface via said docking connector universal serial bus interface, a data interface to an external computer via said docking connector data interface and a control interface to an external computer via said docking connector control interface.

41. A method of delivering content to a remote player, comprising the steps of:
controlling a transceiver link associated with a content server for communicating with the remote player;
accepting user content preferences for storage accessible by the content server;
locating content responsive to the user content preferences on the content server; and
establishing communication with the remote player and using the transceiver link to download content to storage on the remote player responsive to the user content preferences.

42. The method of delivering content to a remote player in accordance with claim 41 wherein the step of using the transceiver link includes allocating two or more partitions of the storage on the remote player to a specified content form associated with each of the two or more partitions and managing content stored on the remote player in accordance with the allocated partitions and their respective specified content forms.

43. The method of delivering content to a remote player in accordance with claim 42 wherein the specified content form for one of said two or more allocated partitions is a playlist, whereby the allocated partition of the storage on the remote player is limited to the content of the playlist and content specified in the playlist is stored only when space is available in the allocated partition.

44. The method of delivering content to a remote player in accordance with claim 42 wherein the specified content forms comprise two or more of music content data, voice data and PDA data.

45. The method of claim 41 wherein the step of controlling a transceiver link associated with a content server comprises controlling a wireless transceiver link.

46. The method of claim 41 wherein the step of controlling a transceiver link associated with a content server comprises controlling a wired connection transceiver link.

47. The method of claim 41 wherein the step of controlling a transceiver link associated with a content server comprises controlling a wireless local area network link.

48. A digital accessory for use in a vehicle having a battery and an electrical system with a charging circuit for recharging the battery, said digital accessory having an on-state and a standby-state, comprising:
a power connection for connecting the accessory to a vehicle's electrical system to derive operating power;
a power sensor for sensing operation of the charging circuit; and
a switch responsive to the power sensor for placing the accessory in the on-state when the power sensor indicates that the charging circuit is recharging the battery and placing the accessory in the standby state when the power sensor indicates that the charging circuit is not recharging the battery.

49. The digital accessory of claim 48 wherein the digital accessory is a content player.

50. The digital accessory of claim 49 further comprising a wireless link to a content server and means for enabling a download from the content server notwithstanding the stand-by-state of the accessory.

51. The digital accessory of claim 50 wherein the means for enabling a download comprises memory for storing a time for a scheduled download event and for activating the accessory to the on state in response to the time for the scheduled download event.

52. The digital accessory of claim 49 wherein the digital accessory has a general purpose data processor and a program component running on the general purpose data processor for maintaining vehicle service information.
